(19) United States
(12) Patent Application Publication
(10) Pub. No.: US 2026/0175649 A1
(43) Pub. Date: Jun. 25, 2026

(54) VEHICLE AIR VENT

(71) Applicant: HYUNDAI MOBIS CO., LTD., Seoul (KR)

(72) Inventor: Seung Cheol KIM, Yongin-si (KR)

(73) Assignee: HYUNDAI MOBIS CO., LTD., Seoul (KR)

(21) Appl. No.: 19/240,359

(22) Filed: Jun. 17, 2025

(30) Foreign Application Priority Data
Dec. 23, 2024 (KR) 10-2024-0193521

(51) Int. Cl. B60H 1/34

(52) U.S. Cl. CPC B60H 1/3421

(57) ABSTRACT

A vehicle air vent includes: a housing including a plurality of branch portions that branch air flowing inward in an upward or downward direction; a garnish disposed in front of the housing and connected to the housing; a first wing unit disposed in an inlet portion of the housing to allow at least one of the plurality of branch portions in the housing to be closed while being moved linearly inside the housing; a second wing unit disposed in an outlet portion of the housing to guide a movement direction of air while being rotated inside the housing; and a handle assembly connected to the first wing unit and the second wing unit. The handle assembly includes a knob unit that passes through the garnish and is disposed inside and outside the garnish to determine a movement direction of air passing through the garnish.

### CROSS REFERENCE TO RELATED APPLICATION

This application claims priority to and the benefit of Korean Patent Application No. 10-2024-0193521, filed on Dec. 23, 2024, the disclosure of which is incorporated herein by reference in its entirety.

### BACKGROUND

### 1. Field of the Invention

The present invention relates to a vehicle air vent.

### 2. Description of Related Art

An air vent is a device connected to an air conditioning system to guide air discharged from the air conditioning system into the interior of a vehicle. The air vent may include a housing through which air passes, a front wing that is disposed inside the housing and controls wind in a left-right direction, a rear wing that is disposed inside the housing and controls wind in an up-down direction, and a knob that is coupled to the rear wing and operated by a user.

The conventional air vent is structured to be coupled to a cockpit of a vehicle and exposed toward a passenger room, and in this case, a user operates a front wing or rear wing with a knob. However, because the front wing and knob are exposed to occupants, they contribute to a decrease in aesthetics. Therefore, there has recently been a demand for an air vent design that eliminates the knob from the air vent and does not expose the front wing to occupants.

For this purpose, a plurality of actuators to be coupled to the front wing and the rear wing are used for rotating the front wing and the rear wing without exposure to occupants.

However, when a plurality of actuators are used, there is a problem of reduced productivity due to increased manufacturing costs. Therefore, there is an increasing need for a structure capable of controlling the front wing and rear wing without actuators.

### SUMMARY

The present invention is devised to solve the above problems, and one embodiment of the present invention is directed to providing an improved vehicle air vent which allows a front wing and a rear wing to be manually controlled without an actuator in an air vent structure in which the front wing and the rear wing are not exposed.

According to one embodiment of the present invention, there is provided a vehicle air vent including: a housing including a plurality of branch portions that branch air flowing inward in an upward or downward direction; a garnish disposed in front of the housing and connected to the housing; a first wing unit disposed in an inlet portion of the housing to allow at least one of the plurality of branch portions in the housing to be closed while being moved linearly inside the housing; a second wing unit disposed in an outlet portion of the housing to guide a movement direction of air while being rotated inside the housing; and a handle assembly connected to the first wing unit and the second wing unit, wherein the handle assembly includes a knob unit that passes through the garnish and is disposed inside and outside the garnish to determine a movement direction of air passing through the garnish.

The knob unit may include a knob main body that is pressed by an external force, and the knob main body may be exposed through the garnish, and the first wing unit and the second wing unit may not be exposed through the garnish.

The handle assembly may include: a gear unit disposed on an outer side of the housing and connected to the first wing unit to linearly move the first wing unit; and a link unit that connects the knob unit and the gear unit.

The plurality of branch portions of the housing may include a first branch portion and a second branch portion, and the first wing unit may include: a first wing plate that is movable to close the first branch portion of the housing; and a second wing plate spaced apart from the first wing plate and movable to close the second branch portion of the housing.

The first wing plate and the second wing plate of the first wing unit may be moved linearly in opposite directions while the gear unit is operated by the link unit moved in conjunction with movement of the knob unit.

The gear unit of the handle assembly may include: a first pinion portion coupled to the first wing plate; a second pinion portion spaced apart from the first pinion portion and coupled to the second wing plate; and a third pinion portion disposed between the first pinion portion and the second pinion portion, and which connects the first pinion portion and the second pinion portion, and is connected to the link unit.

The handle assembly may include a connecting unit that connects the knob unit and the second wing unit.

The connecting unit of the handle assembly may include: a first connector connected to the second wing unit; and a second connector that rotatably supports the knob unit and is engaged and connected with the first connector.

The second connector of the connecting unit may rotate the first connector while being moved linearly in conjunction with movement of the knob unit.

The housing and the garnish may form a space that accommodates a part of the handle assembly in a state in which the housing and the garnish are connected.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view showing a vehicle air vent according to one embodiment of the present invention;

FIG. 2 is a perspective view showing a disassembled state of the vehicle air vent according to one embodiment of the present invention;

FIG. 3 is a perspective view showing a housing;

FIG. 4 is a cross-sectional view showing the interior of the housing;

FIG. 5 is a perspective view showing a garnish;

FIG. 6A is a rear perspective view showing the garnish;

FIG. 6B is a cross-sectional view showing the interior of the garnish and the housing in a state in which the garnish is coupled to the housing;

FIG. 7 is a perspective view showing a first wing unit;

FIG. 8 is a perspective view showing the first wing unit that is disposed in the housing;

FIG. 9 is a perspective view showing a second wing unit that is disposed in the housing;

FIG. 10 is a disassembled perspective view showing a handle assembly;

FIG. 11 is a perspective view showing a knob unit;

FIG. 12 is a view showing a gear unit that is coupled to the first wing unit while disposed on an outer side of the housing;

FIG. 13 is a perspective view showing a link unit;

FIG. 14 is a view showing the link unit that connects the knob unit and the gear unit;

FIG. 15 is a perspective view showing a connecting unit;

FIG. 16 is a view showing the connecting unit that is connected to the knob unit and the second wing unit;

FIG. 17 is a view showing a connection state of the housing, the first wing unit, the second wing unit, and the handle assembly;

FIG. 18 is a side view showing a state in which the housing, the garnish, and the handle assembly are connected to each other;

FIG. 19 is a view showing a side cover that is disposed in the housing;

FIGS. 20A and 20B are views showing a first wing plate and a second wing plate that are disposed at a first position;

FIGS. 21A and 21B are views showing the first wing plate and the second wing plate that are disposed at a second position;

FIGS. 22A and 22B are views showing the first wing plate and the second wing plate that are disposed at a third position;

FIG. 23 is a view showing the second wing unit that is disposed in a fourth position;

FIG. 24 is a view showing the second wing unit that is disposed at a fifth position; and

FIG. 25 is a view showing the second wing unit that is disposed at a sixth position.

### DETAILED DESCRIPTION

The present invention may undergo various modifications and have various embodiments, and specific embodiments will be illustrated in the drawings and described. However, this is not intended to limit the present invention to specific embodiments, and it should be understood that the present invention includes all modifications, equivalents, or substitutes included in the spirit and technical scope of the present invention.

Terms including ordinal numbers, such as “first,” “second,” etc., may be used to describe various components, but the components are not limited by the terms. The terms are used only to distinguish one component from another component. For example, without departing from the scope of the present invention, a second component can be named a first component, and similarly, a first component can also be named a second component. The term “and/or” includes any combination of a plurality of related described items or any item among a plurality of related described items.

When it is described that one component is “connected” or “coupled” to another component, it should be understood that the one component may be directly connected or coupled to the other component, or there may be other components therebetween. On the other hand, when it is described that one component is “directly connected” or “directly coupled” to another component, it should be understood that there are no other components therebetween.

In the description of embodiments, when one component is described as being formed “on or under” another component, “on or under” includes both cases in which the two components are in direct contact with each other and one or more other components are disposed between the two components. In addition, when expressed as “on or under,” it may include the meaning of not only an upward direction but also a downward direction based on one component.

Terms used in this application are used only to describe specific embodiments and are not intended to limit the present invention. A singular expression includes a plural expression unless the context clearly indicates otherwise. In this application, it should be understood that terms such as “include” and “have” are intended to specify that a feature, number, step, operation, component, part, or combination thereof described in the specification is present, and do not exclude in advance the possibility of the presence or addition of one or more other features, numbers, steps, operations, components, parts or combinations thereof.

Unless otherwise defined, all terms used herein, including technical or scientific terms, have the same meaning as commonly understood by those skilled in the art to which the present invention belongs. Terms defined in commonly used dictionaries should be interpreted as having a meaning consistent with their meaning in the context of the related art and will not be interpreted in an idealized or overly formal sense unless expressly defined in this application.

Hereinafter, a vehicle air vent will be described in detail with reference to the accompanying drawings, the same or corresponding components are denoted by the same reference signs throughout the drawings, and overlapping description thereof will be omitted.

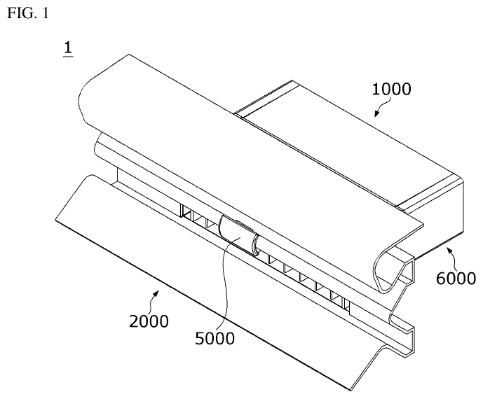

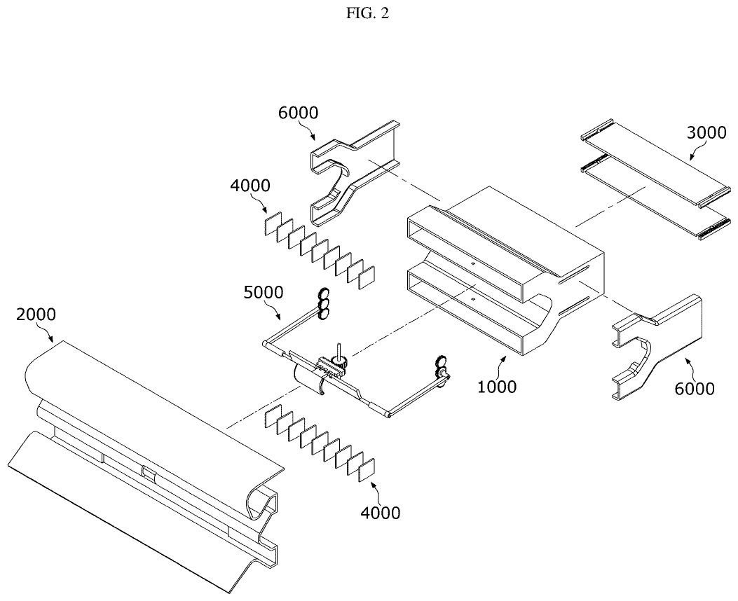

FIG. 1 is a perspective view showing a vehicle air vent according to one embodiment of the present invention, and FIG. 2 is a perspective view showing a disassembled state of the vehicle air vent according to one embodiment of the present invention.

Referring to FIGS. 1 and 2, a vehicle air vent 1 according to one embodiment of the present invention may be installed in a vehicle to guide air. More specifically, the vehicle air vent 1 may be connected to an air conditioning system (not shown) and guide air discharged from the air conditioning system toward a passenger room of the vehicle. The vehicle air vent 1 includes a housing 1000, a garnish 2000, a first wing unit 3000, a second wing unit 4000, a handle assembly 5000, and a side cover 6000.

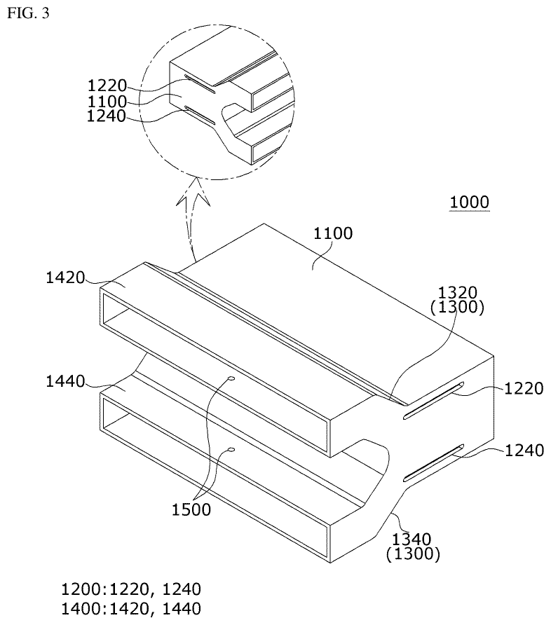

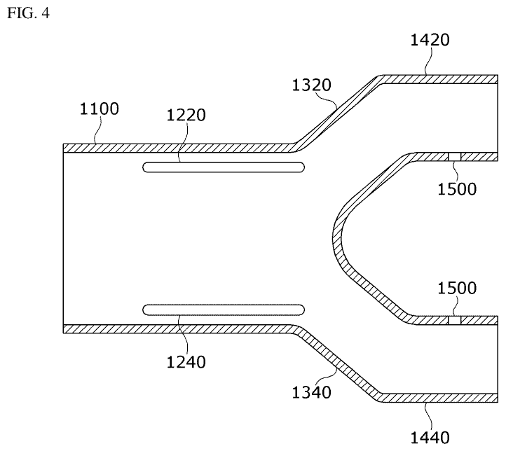

FIG. 3 is a perspective view showing the housing, and FIG. 4 is a cross-sectional view showing the interior of the housing.

Referring to FIGS. 1 and 2, the housing 1000 may accommodate the first wing unit 3000 and the second wing unit 4000 and form a path through which air flows. More specifically, the housing 1000 may be connected to the air conditioning system and receive air discharged from the air conditioning system or moved through a duct connected to the air conditioning system. The housing 1000 may have a hollow shape to form an air flow path. The housing 1000 may include an inlet portion 1100, a first guide portion 1200, a branch portion 1300, an outlet portion 1400, and a first accommodation portion 1500.

The inlet portion 1100 may be a portion through which air flows into the interior of the housing 1000. The first wing unit 3000 may be disposed in the inlet portion 1100.

The first guide portion 1200 may be formed in the inlet portion 1100. The first guide portion 1200 may be formed on one side and the other side of the housing 1000 that forms the inlet portion 1100. The guide portion may include a 1-1 guide portion 1220 formed in an upper end portion of one side and the other side of the housing 1000 and a 1-2 guide portion 1240 formed in a lower end portion of one side and the other side of the housing 1000. The 1-1 guide portion 1220 and the 1-2 guide portion 1240 may be disposed in a direction in which the inlet portion 1100 is disposed. The first guide portion 1200 may guide a movement direction of a first wing plate 3100 and a second wing plate 3200 to be described below.

The branch portion 1300 may be disposed in an end portion of the inlet portion 1100. The branch portion 1300 may branch the air flowing into the interior of the housing 1000 upward or downward. The branch portion 1300 may include a first branch portion 1320 and a second branch portion 1340.

The first branch portion 1320 may be disposed in an upper end portion of the inlet portion 1100. The first branch portion 1320 may have a shape that protrudes from the end portion of the inlet portion 1100 to be inclined with respect to the inlet portion 1100. The first branch portion 1320 may be disposed to be inclined upward from the inlet portion 1100.

The second branch portion 1340 may be disposed in a lower end portion of the inlet portion 1100. The second branch portion 1340 may have a shape that protrudes from the end portion of the inlet portion 1100 to be inclined with respect to the inlet portion 1100. The second branch portion 1340 may be disposed to be inclined downward from the inlet portion 1100. The second branch portion 1340 may have a shape symmetrical to that of the first branch portion 1320.

The outlet portion 1400 may be connected to the branch portion 1300. The outlet portion 1400 may include a first outlet portion 1420 connected to the first branch portion 1320 and a second outlet portion 1440 connected to the second branch portion 1340. Accordingly, the first outlet portion 1420 and the second outlet portion 1440 may be disposed to be spaced apart from each other. The second wing unit 4000 may be disposed in the outlet portion 1400. More specifically, a 2-1 wing unit 4100 to be described below may be disposed in the first outlet portion 1420, and a 2-2 wing unit 4200 to be described below may be disposed in the second outlet portion 1440.

The first accommodation portion 1500 may be formed in each of the first outlet portion 1420 and the second outlet portion 1440. The first accommodation portion 1500 may be a hole passing through a part of each of the first outlet portion 1420 and the second outlet portion 1440. The first accommodation portion 1500 may accommodate an end portion of a pillar portion 5414 of a connecting unit 5400 to be described below. Additionally, the first accommodation portion 1500 may allow the end portion of the pillar portion 5414 to pass therethrough.

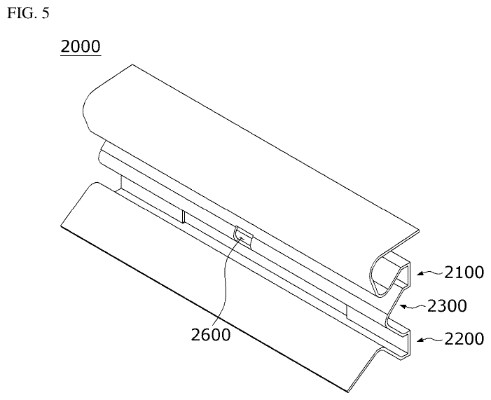

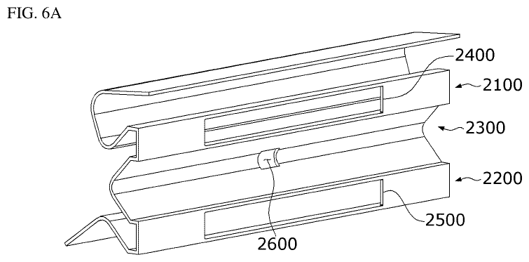

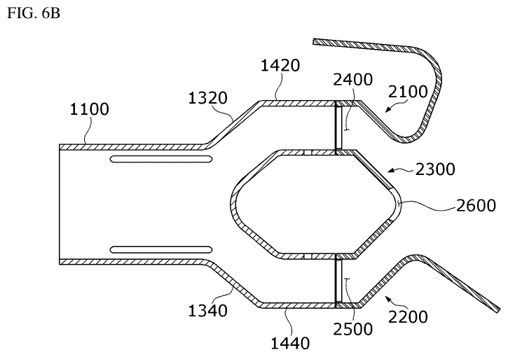

FIG. 5 is a perspective view showing the garnish, FIG. 6A is a rear perspective view showing the garnish, and FIG. 6B is a cross-sectional view showing the interior of the garnish and the housing in a state in which the garnish is coupled to the housing.

Referring to FIGS. 5 to 6B, the garnish 2000 may be disposed in front of the housing 1000 and connected to the housing 1000. The garnish 2000 may guide a movement direction of air passing through the housing 1000. The garnish 2000 may include a 2-1 guide portion 2100, a 2-2 guide portion 2200, a third guide portion 2300, a first communication portion 2400, a second communication portion 2500, and a second accommodation portion 2600.

The 2-1 guide portion 2100 may be coupled to the first outlet portion 1420 of the housing 1000. The 2-1 guide portion 2100 may guide the movement direction of the air passing through the first outlet portion 1420 of the housing 1000. More specifically, based on FIG. 6B, the 2-1 guide portion 2100 may guide the movement direction of the air passing through the first outlet portion 1420 of the housing 1000 downward.

The 2-2 guide portion 2200 may be coupled to the second outlet portion 1440 of the housing 1000. The 2-2 guide portion 2200 may guide the movement direction of the air passing through the second outlet portion 1440 of the housing 1000. More specifically, based on FIG. 6B, the 2-2 guide portion 2200 may guide the movement direction of the air passing through the second outlet portion 1440 of the housing 1000 upward.

The third guide portion 2300 may connect the 2-1 guide portion 2100 and the 2-2 guide portion 2200. The third guide portion 2300 may have a wedge shape, wherein the third guide portion 2300 may be disposed parallel to a shape of a part of the 2-1 guide portion 2100 and disposed parallel to a shape of a part of the 2-2 guide portion 2200.

The first communication portion 2400 may be formed in the 2-1 guide portion 2100. The first communication portion 2400 may communicate with the first outlet portion 1420 of the housing 1000. Accordingly, the first communication portion 2400 may allow the air passing through the first outlet portion 1420 of the housing 1000 to pass therethrough, thereby guiding the air to the 2-1 guide portion 2100.

The second communication portion 2500 may be formed in the 2-2 guide portion 2200. The second communication portion 2500 may communicate with the second outlet portion 1440 of the housing 1000. Accordingly, the second communication portion 2500 may allow the air passing through the second outlet portion 1440 of the housing 1000 to pass therethrough, thereby guiding the air to the 2-2 guide portion 2200.

The second accommodation portion 2600 may be formed in the third guide portion 2300. The second accommodation portion 2600 may be a hole passing through the third guide portion 2300. The second accommodation portion 2600 may accommodate a part of a knob unit 5100 to be described below. Additionally, the second accommodation portion 2600 may provide a space in which the knob unit 5100 to be described below may be moved.

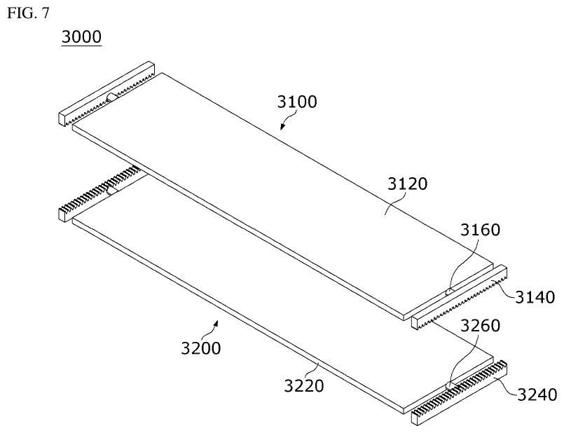

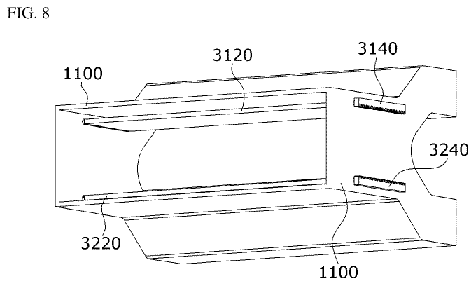

FIG. 7 is a perspective view showing the first wing unit, and FIG. 8 is a perspective view showing the first wing unit that is disposed in the housing.

Referring to FIGS. 7 and 8, the first wing unit 3000 may be disposed in the inlet portion 1100 of the housing 1000. The first wing unit 3000 may include a first wing plate 3100 and a second wing plate 3200.

The first wing plate 3100 may include a first stopping portion 3120, a first rack portion 3140, and a first separation portion 3160.

The first stopping portion 3120 may be disposed on an upper end side of the inlet portion 1100 of the housing 1000 inside the housing 1000. The first stopping portion 3120 may have a shape formed by extending a rectangular cross-section. That is, the first stopping portion 3120 may be a rectangular parallelepiped.

The first rack portion 3140 may be disposed outside the housing 1000. The first rack portion 3140 disposed outside the housing 1000 may be disposed to be collinear with the first stopping portion 3120. The first rack portion 3140 may have a plurality of wedge-shaped gear teeth disposed on a surface facing a gear unit 5200 to be described below.

The first separation portion 3160 may be disposed between the first stopping portion 3120 and the first rack portion 3140. The first separation portion 3160 may connect the first stopping portion 3120 and the first rack portion 3140 and may be movably accommodated in the 1-1 guide portion 1220 of the housing 1000. Accordingly, when the first separation portion 3160 is moved along the 1-1 guide portion 1220 of the housing 1000, the first stopping portion 3120 and first rack portion 3140 connected to the first separation portion 3160 may be moved together with the first separation portion 3160.

The second wing plate 3200 may include a second stopping portion 3220, a second rack portion 3240, and a second separation portion 3260.

The second stopping portion 3220 may be disposed on a lower end side of the inlet portion 1100 of the housing 1000 inside the housing 1000. The second stopping portion 3220 may have a shape formed by extending a rectangular cross-section. That is, the second stopping portion 3220 may be a rectangular parallelepiped.

The second rack portion 3240 may be disposed outside the housing 1000. The second rack portion 3240 disposed outside the housing 1000 may be disposed to be collinear with the second stopping portion 3220. The second rack portion 3240 may have a plurality of wedge-shaped gear teeth disposed on a surface facing the gear unit 5200 to be described below.

The second separation portion 3260 may be disposed between the second stopping portion 3220 and the second rack portion 3240. The second separation portion 3260 may connect the second stopping portion 3220 and the second rack portion 3240 and may be movably accommodated in the 1-2 guide portion 1240 of the housing 1000. Accordingly, when the second separation portion 3260 is moved along the 1-2 guide portion 1240 of the housing 1000, the second stopping portion 3220 and second rack portion 3240 connected to the second separation portion 3260 may be moved together with the second separation portion 3260.

The first wing plate 3100 and second wing plate 3200 may have a symmetrical shape. Additionally, the first wing plate 3100 and the second wing plate 3200 may be disposed such that the gear teeth of the first rack portion 3140 and the gear teeth of the second rack portion 3240 face each other while having the same shape. In this way, the first wing plate 3100 may be moved to close the first branch portion 1320 of the housing 1000. Additionally, the second wing plate 3200 may be disposed to be spaced apart from the first wing plate 3100 and moved to close the second branch portion 1340 of the housing 1000. That is, the first wing unit 3000 may close at least one of a plurality of branch portions 1300 in the housing 1000 while being moved linearly inside the housing 1000.

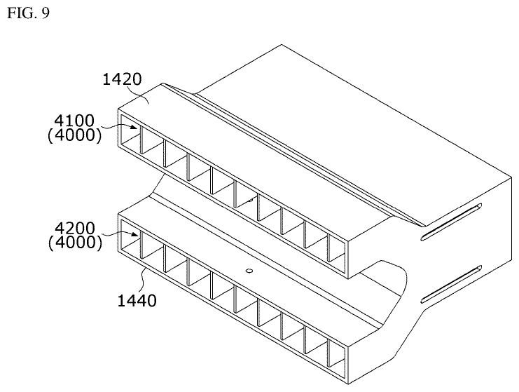

FIG. 9 is a perspective view showing the second wing unit that is disposed in the housing.

Referring to FIG. 9, the second wing unit 4000 may be disposed in the outlet portion 1400 of the housing 1000. The second wing unit 4000 may guide the movement direction of the air while being rotated inside the housing 1000. The second wing unit 4000 may include a 2-1 wing unit 4100 disposed in the first outlet portion 1420 of the housing 1000 and a 2-2 wing unit 4200 disposed in the second outlet portion 1440 of the housing 1000. Each of the 2-1 wing unit 4100 and the 2-2 wing unit 4200 may have a plurality of blades disposed to be spaced apart from each other inside the first outlet portion 1420 and the second outlet portion 1440 of the housing 1000. The second wing unit 4000 may be connected to the connecting unit 5400 to be described below and rotated in conjunction with the movement of the connecting unit 5400. Here, although not shown, a spacer may be disposed in each of the 2-1 wing unit 4100 and the 2-2 wing unit 4200. The spacer may connect the plurality of blades constituting the 2-1 wing unit 4100 and connect the plurality of blades constituting the 2-2 wing unit 4200.

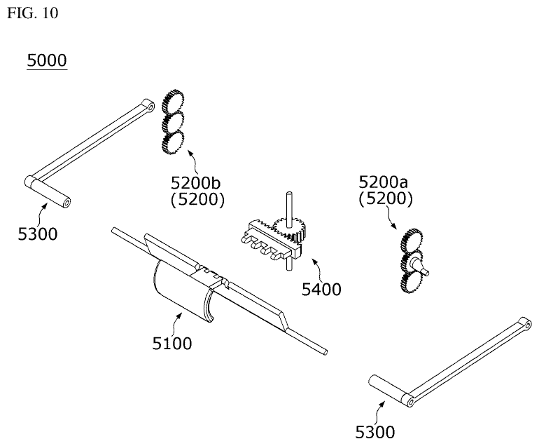

FIG. 10 is a disassembled perspective view showing the handle assembly.

Referring to FIG. 10, the handle assembly 5000 may be connected to the first wing unit 3000 and the second wing unit 4000. The handle assembly 5000 may include a knob unit 5100, a gear unit 5200, a link unit 5300, and a connecting unit 5400.

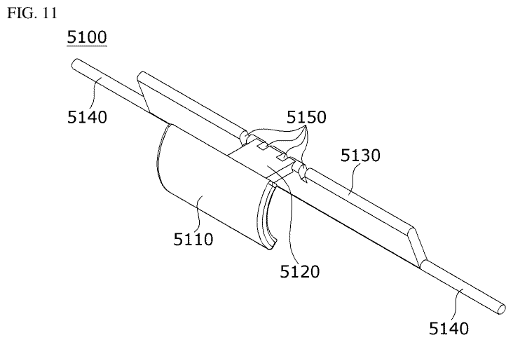

FIG. 11 is a perspective view showing the knob unit.

Referring to FIG. 11, the knob unit 5100 may determine the movement direction of the air passing through the garnish 2000. The knob unit 5100 may include a knob main body 5110, a first support portion 5120, a second support portion 5130, a third support portion 5140, and third accommodation portions 5150.

The knob main body 5110 may be disposed outside the garnish 2000. The knob main body 5110 may be pressed by an external force. More specifically, when the body of a user comes into contact with the knob main body 5110, the knob main body 5110 may be moved by being pressed by a force generated from the user. That is, the knob main body 5110 may be moved from the outside of the garnish 2000. The knob main body 5110 may have a curved shape, but the present invention is not limited thereto.

The first support portion 5120 may be connected to the knob main body 5110. The first support portion 5120 may be movably disposed in the second accommodation portion 2600 of the garnish 2000. The first support portion 5120 may pass through the second accommodation portion 2600 of the garnish 2000 and pass through the third guide portion 2300 of the garnish 2000. Accordingly, the first support portion 5120 may be disposed across the outside and the inside of the garnish 2000. The first support portion 5120 may be moved inside the second accommodation portion 2600 of the garnish 2000 in conjunction with the movement of the knob main body 5110.

The second support portion 5130 may be connected to the first support portion 5120. The second support portion 5130 may be disposed inside the garnish 2000 while connected to the first support portion 5120. More specifically, the second support portion 5130 may be disposed inside the third guide portion 2300 of the garnish 2000. The second support portion 5130 may have a shape bent from the first support portion 5120. The second support portion 5130 may be formed integrally with the first support portion 5120, but the present invention is not limited thereto.

The third support portion 5140 may be disposed in each of both end portions of the second support portion 5130. The third support portion 5140 may have a cylindrical shape protruding from each of both end portions of the second support portion 5130. The third support portion 5140 may be movably disposed in a fourth accommodation portion 5310 of the link unit 5300 to be described below. Accordingly, the third support portion 5140 may be moved inside the fourth accommodation portion 5310 of the link unit 5300 to be described below along with the first support portion 5120 and the second support portion 5130 which is moved in conjunction with the movement of the knob main body 5110. In addition, the third support portion 5140 may pull the fourth accommodation portion 5310 of the link unit 5300 to be described below while moving along with the first support portion 5120 and the second support portion 5130 which is moved in conjunction with the movement of the knob main body 5110.

The third accommodation portions 5150 may be formed in the first support portion 5120 and the second support portion 5130. The third accommodation portions 5150 may be grooves formed in end portions of the first support portion 5120 and the second support portion 5130. The third accommodation portion 5150 may rotatably accommodate a part of the second connector 5420, which will be described below, of the connecting unit 5400.

The knob unit 5100 may pass through the garnish 2000 and may be disposed inside and outside the garnish 2000 to determine the movement direction of the air passing through the garnish 2000. In particular, since the knob main body 5110 is disposed outside the garnish 2000, the need for a separate power device for operating the first wing unit 3000 and the second wing unit 4000 may be eliminated. Therefore, manufacturing costs can be reduced.

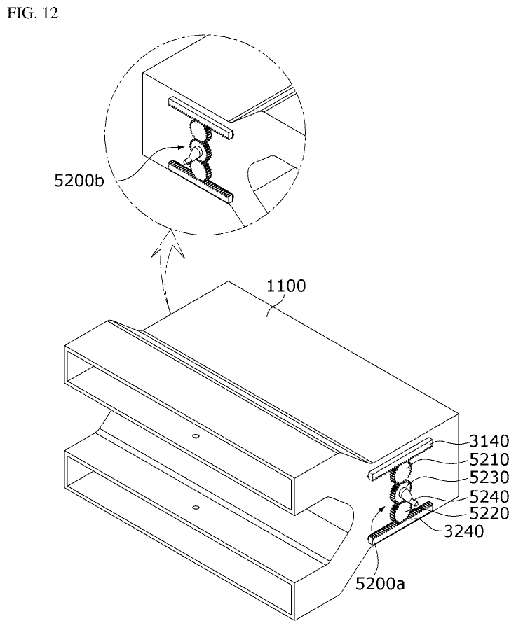

FIG. 12 is a view showing the gear unit that is coupled to the first wing unit while disposed on an outer side of the housing.

Referring to FIG. 12, the gear unit 5200 may be disposed on the outer side of the housing 1000 and connected to the first wing unit 3000 to linearly move the first wing unit 3000. The gear unit 5200 may include a first gear unit 5200a and a second gear unit 5200b disposed in both end portions of the housing 1000, and the first gear unit 5200a and the second gear unit 5200b may have a symmetrical shape. The gear unit 5200 may include a first pinion portion 5210, a second pinion portion 5220, a third pinion portion 5230, and a protrusion 5240.

The first pinion portion 5210 may be coupled to the first wing plate 3100. More specifically, the first pinion portion 5210 may be engaged and coupled with the first rack portion 3140 of the first wing plate 3100 of the first wing unit 3000. The first pinion portion 5210 may include a circular plate and a plurality of gear teeth disposed on an outer circumferential surface of the circular plate.

The second pinion portion 5220 may be disposed to be spaced apart from the first pinion portion 5210. The second pinion portion 5220 may be coupled to the second wing plate 3200. More specifically, the second pinion portion 5220 may be engaged and coupled with the second rack portion 3240 of the second wing plate 3200 of the first wing unit 3000. The second pinion portion 5220 may include a circular plate and a plurality of gear teeth disposed on an outer circumferential surface of the circular plate.

The third pinion portion 5230 may be disposed between the first pinion portion 5210 and the second pinion portion 5220 to connect the first pinion portion 5210 and the second pinion portion 5220. The third pinion portion 5230 may include a circular plate and a plurality of gear teeth disposed on an outer circumferential surface of the circular plate.

The protrusion 5240 may be disposed on the third pinion portion 5230. The protrusion 5240 may be connected to the link unit 5300. Accordingly, the third pinion portion 5230 may be rotated along with the protrusion 5240 that is rotated in conjunction with the movement of the link unit 5300. When the third pinion portion 5230 is rotated by the protrusion 5240, the first pinion portion 5210 and the second pinion portion 5220 may be rotated in different directions. The protrusion 5240 may be rotated around the third pinion portion 5230 as the center of rotation.

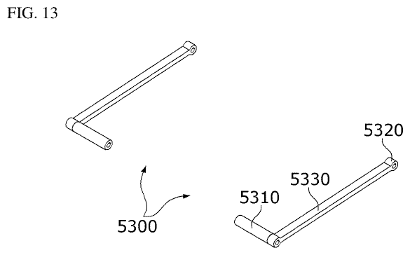

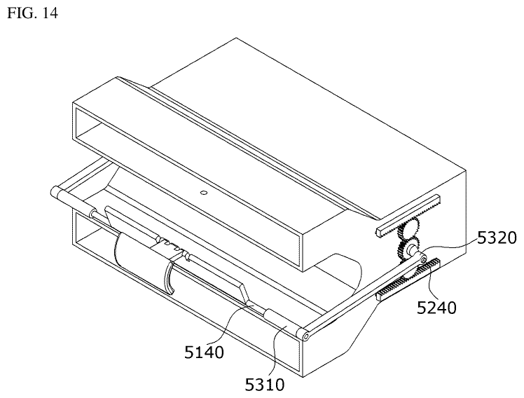

FIG. 13 is a perspective view showing the link unit, and FIG. 14 is a view showing the link unit that connects the knob unit and the gear unit.

Referring to FIGS. 13 and 14, the link unit 5300 may connect the knob unit 5100 and the gear unit 5200. The link unit 5300 may be disposed outside the housing 1000. The link unit 5300 may include a fourth accommodation portion 5310, a fifth accommodation portion 5320, and a link plate 5330.

The fourth accommodation portion 5310 may have a hollow cylindrical shape. The fourth accommodation portion 5310 may movably accommodate the third support portion 5140 of the knob unit 5100. The fourth accommodation portion 5310 may be moved in conjunction with the movement of the knob unit 5100.

The fifth accommodation portion 5320 may have a hollow cylindrical shape. The fifth accommodation portion 5320 may be disposed to be spaced apart from the fourth accommodation portion 5310. The fifth accommodation portion 5320 may be coupled to the protrusion 5240 of the gear unit 5200. The fifth accommodation portion 5320 may rotate the protrusion 5240 of the gear unit 5200 while being moved in conjunction with the movement of the link plate 5330.

The link plate 5330 may be disposed between the fourth accommodation portion 5310 and the fifth accommodation portion 5320 to connect the fourth accommodation portion 5310 and the fifth accommodation portion 5320. The link plate 5330 may move the fifth accommodation portion 5320 in conjunction with the movement of the fourth accommodation portion 5310.

Accordingly, the first wing plate 3100 and the second wing plate 3200 of the first wing unit 3000 may be moved linearly in opposite directions while the gear unit 5200 is operated by the link unit 5300 that is moved in conjunction with the movement of the knob unit 5100. Accordingly, in a manual air vent structure in which the knob is manually operated rather than electrically operated, the movement direction of the air passing through the housing 1000 may be guided. Accordingly, since the need for a separate power device for moving the first wing plate 3100 and the second wing plate 3200 is eliminated, the manufacturing cost can be reduced, and the power loss due to the use of a separate power device and the cost due to power usage can be reduced.

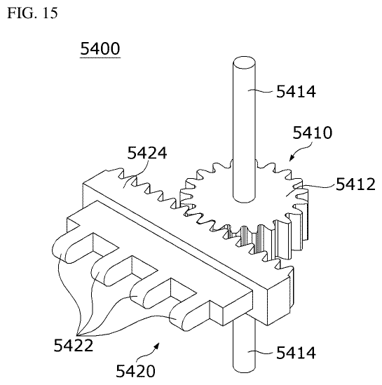

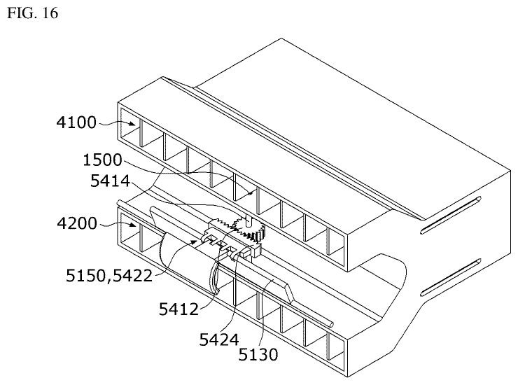

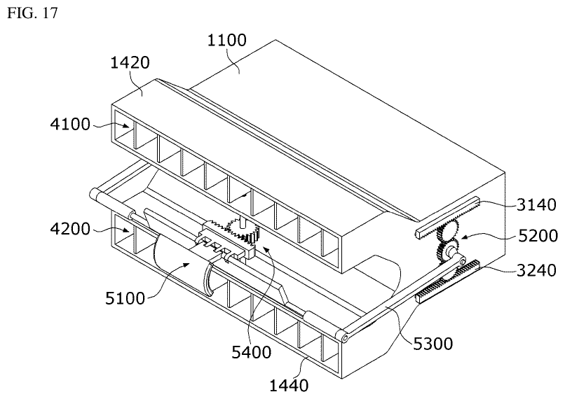

FIG. 15 is a perspective view showing the connecting unit, FIG. 16 is a view showing the connecting unit that is connected to the knob unit and the second wing unit, and FIG. 17 is a view showing a connection state of the housing, the first wing unit, the second wing unit, and the handle assembly.

Referring to FIGS. 15 to 17, the connecting unit 5400 may connect the knob unit 5100 and the second wing unit 4000. The connecting unit 5400 may include a first connector 5410 and a second connector 5420.

The first connector 5410 may be connected to the second wing unit 4000. The first connector 5410 may include a fourth pinion portion 5412 and a pillar portion 5414.

The fourth pinion portion 5412 may include a circular plate and a plurality of gear teeth disposed on an outer circumferential surface of the circular plate. The fourth pinion portion 5412 may be rotated in place by the second connector 5420.

The pillar portion 5414 may have a cylindrical shape protruding from one surface and the other surface of the fourth pinion portion 5412. One end portion of the pillar portion 5414 may be fixed to the fourth pinion portion 5412, and the other end portion may be accommodated in the first accommodation portion 1500 of the housing 1000. Additionally, the other end portion of the pillar portion 5414 may be connected to the 2-1 wing unit 4100 and the 2-2 wing unit 4200 disposed in the first outlet portion 1420 and the second outlet portion 1440, respectively, of the housing 1000 through the first accommodation portion 1500 of the housing 1000.

The first connector 5410 may rotate the 2-1 wing unit 4100 and the second wing unit 4000 while being rotated by the second connector 5420 that is moved in conjunction with the movement of the knob unit 5100.

The second connector 5420 may rotatably support the knob unit 5100 and may be engaged and connected with the first connector 5410. The second connector 5420 may include a first contact portion 5422 and a second contact portion 5424.

The first contact portion 5422 may include a plate having a rectangular parallelepiped shape and a plurality of pins disposed in an end portion of the plate. The plurality of pins of the first contact portion 5422 may be rotatably disposed in the third accommodation portion 5150 of the knob unit 5100. The first contact portion 5422 may be moved in a width direction in conjunction with the movement of the knob unit 5100. Here, the width direction may be a direction intersecting a direction from the inlet portion 1100 toward the outlet portion 1400 of the housing 1000.

The second contact portion 5424 may be connected to the first contact portion 5422. The second contact portion 5424 may be engaged and coupled with the fourth pinion portion 5412 of the first connector 5410. The second contact portion 5424 may be a combination of a plate having a rectangular parallelepiped shape and a plurality of gear teeth formed on one surface of the plate. The second contact portion 5424 may be moved in conjunction with the movement of the first contact portion 5422.

The second connector 5420 of the connecting unit 5400 may rotate the first connector 5410 while being moved linearly in conjunction with the movement of the knob unit 5100.

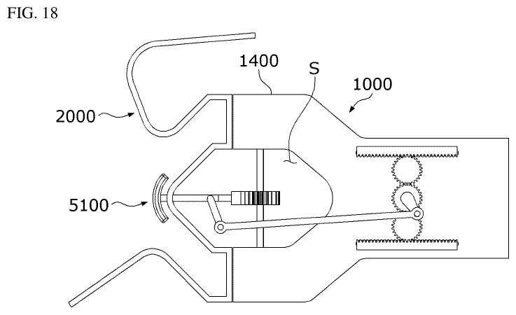

FIG. 18 is a side view showing a state in which the housing, the garnish, and the handle assembly are connected to each other.

Referring to FIG. 18, the housing 1000 and the garnish 2000 may form a space S that accommodates a part of the handle assembly 5000 in a state in which the housing 1000 and the garnish 2000 are connected. Accordingly, since a space in which the knob unit 5100 is movable is secured outside the housing 1000, the phenomenon of covering the outlet portion 1400 of the housing 1000 is prevented, thereby preventing wind loss. In addition, the space S formed by the housing 1000 and the garnish 2000 means that the handle assembly 5000 is disposed at a position at which the handle assembly 5000 does not obscure the interior of the housing 1000, thereby preventing a delay in the movement of the air discharged from the housing 1000 or a decrease in the amount of air discharged, thereby preventing air loss.

Additionally, the knob main body 5110 of the knob unit 5100 may be exposed through the garnish 2000, and the first wing unit 3000 and the second wing unit 4000 may not be exposed through the garnish 2000. Accordingly, in a hidden type air vent structure, only the knob main body 5110 capable of operating the first wing unit 3000 and the second wing unit 4000 without a separate power device is exposed to the user, thereby reducing manufacturing costs while minimizing the loss of design aesthetics of the vehicle interior.

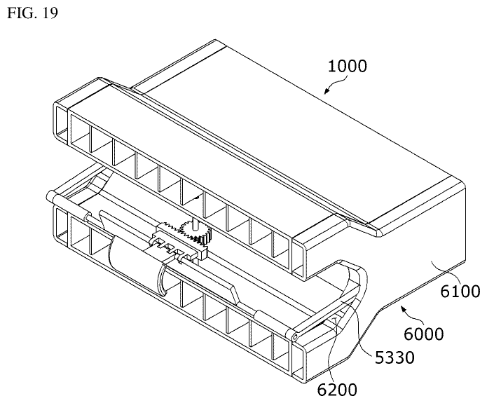

FIG. 19 is a view showing the side cover that is disposed in the housing.

Referring to FIG. 19, the side cover 6000 may be disposed on the outer side of the housing 1000 and disposed on both side portions of the housing 1000. The side cover 6000 may include a cover main body 6100 and a sixth accommodation portion 6200.

The cover main body 6100 may form the exterior of the side cover 6000. The cover main body 6100 may be a thin plate. The cover main body 6100 may have an edge shape corresponding to a side portion shape of the housing 1000. The cover main body 6100 may cover the first rack portion 3140 of the first wing plate 3100 of the first wing unit 3000, the second rack portion 3240 of the second wing plate 3200 of the first wing unit 3000, the gear unit 5200 of the handle assembly 5000, the fifth accommodation portion 5320 of the link unit 5300, and a part of the link plate 5330 of the link unit 5300.

Additionally, an area of the cover main body 6100 close to the outlet portion 1400 of the housing 1000 may have an open shape. Accordingly, air leaking from the inside of the housing 1000 through the first guide portion 1200 of the housing 1000 may be guided (see FIGS. 3 and 4). Therefore, the loss of the amount of air flowing into the housing 1000 may be reduced.

The sixth accommodation portion 6200 may be formed in the cover main body 6100. The sixth accommodation portion 6200 may movably accommodate a part of the link plate 5330 of the link unit 5300 of the handle assembly 5000. Additionally, the sixth accommodation portion 6200 may be provided with a shape having a length greater than or equal to a moving path of the link plate 5330.

Hereinafter, an air guide structure of the vehicle air vent 1 according to one embodiment of the present invention will be described.

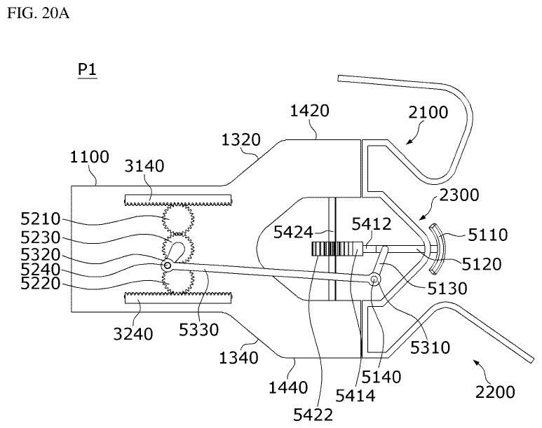

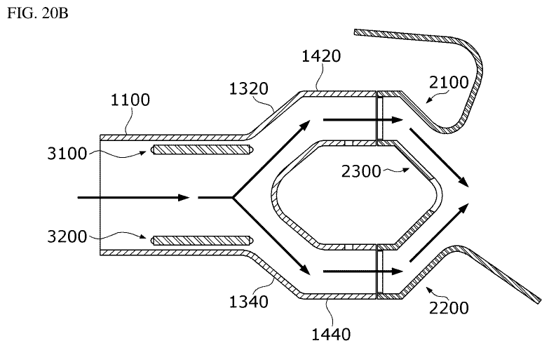

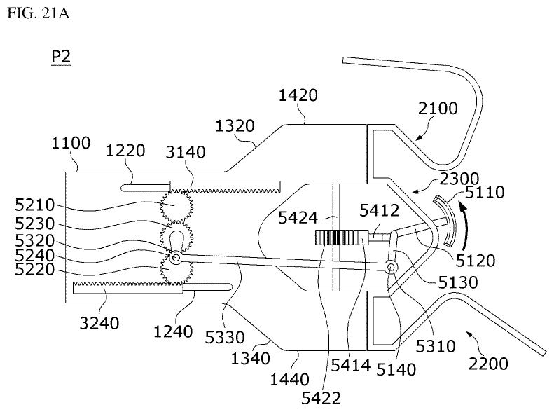

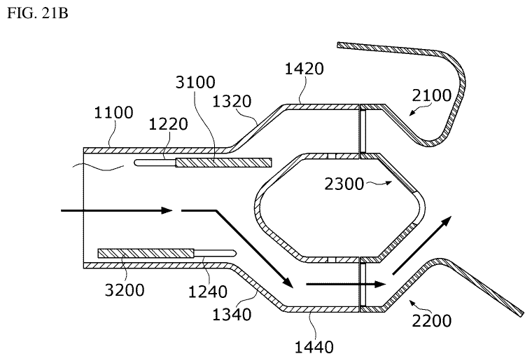

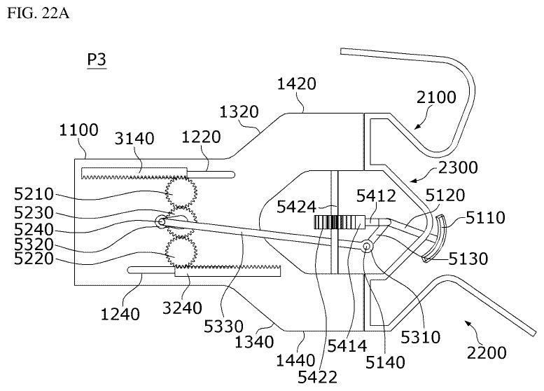

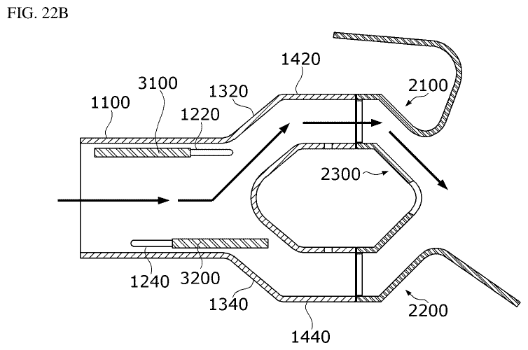

FIGS. 20A and 20B are views showing the first wing plate and the second wing plate that are disposed at a first position, FIGS. 21A and 21B are views showing the first wing plate and the second wing plate that are disposed at a second position, and FIGS. 22A and 22B are views showing the first wing plate and the second wing plate that are disposed at a third position.

A structure in which air is guided by the movement of the first wing unit 3000 is described with reference to FIGS. 20A to 22B.

Referring to FIGS. 20A and 20B, in a state in which no component of the vehicle air vent 1 according to one embodiment of the present invention is in operation, the first wing plate 3100 and the second wing plate 3200 of the first wing unit 3000 are disposed at a first position P1 at which the first branch portion 1320 or the second branch portion 1340 of the housing 1000 is not closed.

Referring to FIGS. 21A and 21B, in this state, the knob main body 5110 may be pressed by the user to be moved toward the 2-1 guide portion 2100 of the garnish 2000. In this case, the knob unit 5100 is rotated around the first contact portion 5422 of the second connector 5420 of the connecting unit 5400 accommodated in the third accommodation portion 5150 as the center of rotation.

In the above process, when the knob main body 5110 of the knob unit 5100 is moved toward the 2-1 guide portion 2100 of the garnish 2000, the link plate 5330 of the link unit 5300 and the fifth accommodation portion 5320 connected to the link plate 5330 are moved along with the fourth accommodation portion 5310 by the fourth accommodation portion 5310 of the link unit 5300 connected to the third support portion 5140 of the knob unit 5100.

Accordingly, the protrusion 5240 disposed on the third pinion portion 5230 of the gear unit 5200 connected to the fifth accommodation portion 5320 of the link unit 5300 is rotated around the third pinion portion 5230 as the center of rotation, and as the protrusion 5240 is rotated, the third pinion portion 5230 is also rotated in place. As the third pinion portion 5230 is rotated, the first pinion portion 5210 and the second pinion portion 5220 that are engaged with the third pinion portion 5230 are also rotated. In this case, as shown in FIG. 21A, the first pinion portion 5210 is rotated clockwise and the second pinion portion 5220 is rotated counterclockwise.

As the first pinion portion 5210 is rotated clockwise, the first rack portion 3140 of the first wing plate 3100 of the first wing unit 3000 engaged with the first pinion portion 5210 is moved toward the first branch portion 1320 of the housing 1000. On the other hand, as the second pinion portion 5220 is rotated counterclockwise, the second rack portion 3240 of the second wing plate 3200 of the first wing unit 3000 engaged with the second pinion portion 5220 is moved in a direction opposite to the direction in which the first rack portion 3140 of the first wing plate 3100 is moved.

Accordingly, the first separation portion 3160 and the first stopping portion 3120 of the first wing plate 3100, which are connected to the first rack portion 3140 of the first wing plate 3100, are moved toward the first branch portion 1320 of the housing 1000, and thus the first stopping portion 3120 is disposed at a position at which the first stopping portion 3120 closes the first branch portion 1320 of the housing 1000. In this way, the first wing plate 3100 and the second wing plate 3200 are disposed at a second position P2 at which the first wing plate 3100 and the second wing plate 3200 close only the first branch portion 1320 of the housing 1000, and a structure in which air may not be moved through the first branch portion 1320 of the housing 1000 is formed.

Accordingly, air flowing into the interior of the housing 1000 through the inlet portion 1100 of the housing 1000 is moved along the inlet portion 1100, the second branch portion 1340, and the second outlet portion 1440 of the housing 1000 and discharged to the outside of the housing 1000. In addition, air that is moved along the second outlet portion 1440 of the housing 1000 and discharged to the outside of the housing 1000 may be moved along the 2-2 guide portion 2200 and a part of the third guide portion 2300 of the garnish 2000 and discharged from the garnish 2000 toward a ceiling surface of the passenger room.

On the other hand, referring to FIGS. 22A and 22B, in a state in which the first wing plate 3100 and the second wing plate 3200 of the first wing unit 3000 are disposed at the first position P1 (see FIGS. 20A and 20B), the knob main body 5110 may be pressed by the user and moved toward the 2-2 guide portion 2200 of the garnish 2000. In this case, the knob unit 5100 is rotated around the first contact portion 5422 of the second connector 5420 of the connecting unit 5400 accommodated in the third accommodation portion 5150 as the center of rotation.

In the above process, when the knob main body 5110 of the knob unit 5100 is moved toward the 2-2 guide portion 2200 of the garnish 2000, the link plate 5330 of the link unit 5300 and the fifth accommodation portion 5320 connected to the link plate 5330 are moved along with the fourth accommodation portion 5310 by the fourth accommodation portion 5310 of the link unit 5300 connected to the third support portion 5140 of the knob unit 5100.

Accordingly, the protrusion 5240 disposed on the third pinion portion 5230 of the gear unit 5200 connected to the fifth accommodation portion 5320 of the link unit 5300 is rotated around the third pinion portion 5230 as the center of rotation, and as the protrusion 5240 is rotated, the third pinion portion 5230 is also rotated in place. As the third pinion portion 5230 is rotated, the first pinion portion 5210 and the second pinion portion 5220 that are engaged with the third pinion portion 5230 are also rotated. In this case, as shown in FIG. 22A, the first pinion portion 5210 is rotated counterclockwise and the second pinion portion 5220 is rotated clockwise.

As the first pinion portion 5210 is rotated counterclockwise, the first rack portion 3140 of the first wing plate 3100 of the first wing unit 3000 engaged with the first pinion portion 5210 is moved away from the first branch portion 1320 of the housing 1000. On the other hand, as the second pinion portion 5220 is rotated clockwise, the second rack portion 3240 of the second wing plate 3200 of the first wing unit 3000 engaged with the second pinion portion 5220 is moved toward the second branch portion 1340 of the housing 1000, that is, in a direction opposite to the direction in which the first rack portion 3140 of the first wing plate 3100 is moved.

Accordingly, the second separation portion 3260 and the second stopping portion 3220 of the second wing plate 3200, which are connected to the second rack portion 3240 of the second wing plate 3200, are moved toward the second branch portion 1340 of the housing 1000, and thus the second stopping portion 3220 is disposed at a position at which the second stopping portion 3220 closes the second branch portion 1340 of the housing 1000. In this way, the first wing plate 3100 and the second wing plate 3200 are disposed at a third position P3 at which the first wing plate 3100 and the second wing plate 3200 close only the second branch portion 1340 of the housing 1000, and a structure in which air may not be moved through the second branch portion 1340 of the housing 1000 is formed.

Accordingly, air flowing into the interior of the housing 1000 through the inlet portion 1100 of the housing 1000 is moved along the inlet portion 1100, the first branch portion 1320, and the first outlet portion 1420 of the housing 1000 and discharged to the outside of the housing 1000. In addition, air that is moved along the first outlet portion 1420 of the housing 1000 and discharged to the outside of the housing 1000 may be moved along the 2-1 guide portion 2100 and a part of the third guide portion 2300 of the garnish 2000 and discharged from the garnish 2000 toward a floor surface of the passenger room.

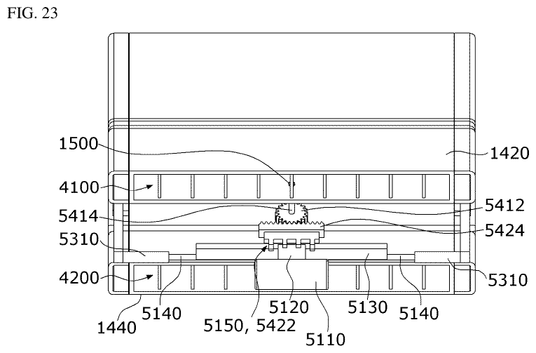

A structure in which air is guided by the movement of the second wing unit 4000 is described with reference to FIGS. 23 to 25.

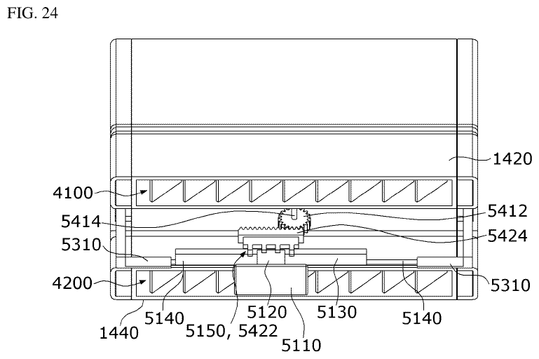

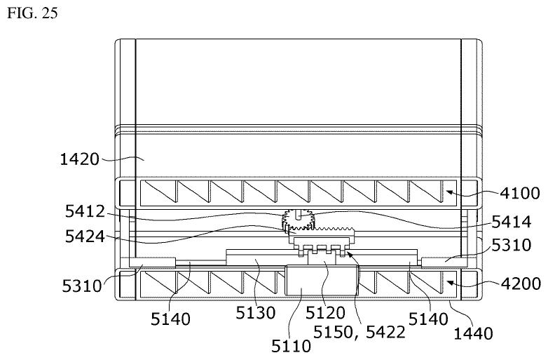

FIGS. 24 and 25 are views showing the second wing unit that is rotated.

Referring to FIG. 23, in a state in which no component of the vehicle air vent 1 according to one embodiment of the present invention is in operation, the 2-1 wing unit 4100 and the 2-2 wing unit 4200 of the second wing unit 4000 maintain a state in which the 2-1 wing unit 4100 and the 2-2 wing unit 4200 are not rotated in any direction inside the first outlet portion 1420 and the second outlet portion 1440 of the housing 1000.

Referring to FIG. 24, in the state of FIG. 23, when the knob main body 5110 is pressed by the user and moved to the left (see FIG. 24), the first support portion 5120, the second support portion 5130, and the third support portion 5140 of the knob unit 5100 are moved along with the knob main body 5110. Here, since the third support portion 5140 is movably accommodated in the fourth accommodation portion 5310 of the link unit 5300, the third support portion 5140 is moved inside the fourth accommodation portion 5310.

As described above, when the knob unit 5100 is moved to the left, the first contact portion 5422 of the second connector 5420 of the connecting unit 5400 accommodated in the third accommodation portion 5150 of the knob unit 5100 is pressed by the first support portion 5120 or the second support portion 5130 of the knob unit 5100 and moved in a direction in which the knob unit 5100 is moved. Here, since the first contact portion 5422 of the first connector 5410 is connected to the second contact portion 5424, the second contact portion 5424 of the first connector 5410 is also moved to the left (see FIG. 24) in conjunction with the movement of the first contact portion 5422.

When the second contact portion 5424 of the first connector 5410 is moved to the left, the fourth pinion portion 5412 of the first connector 5410 of the connecting unit 5400 engaged with the second contact portion 5424 and the pillar portion 5414 of the first connector 5410 which is connected to the fourth pinion portion 5412 are rotated clockwise (see FIG. 24). As the fourth pinion portion 5412 and the pillar portion 5414 of the first connector 5410 are rotated clockwise, the 2-1 wing unit 4100 and the 2-2 wing unit 4200 of the second wing unit 4000 connected to the pillar portion 5414 are rotated clockwise along with the pillar portion 5414. Accordingly, the 2-1 wing unit 4100 and the 2-2 wing unit 4200 may guide air passing through the first outlet portion 1420 and the second outlet portion 1440 of the housing 1000 toward the left side of the housing 1000.

On the other hand, referring to FIG. 25, in the state of FIG. 23, when the knob main body 5110 is pressed by the user and moved to the right (see FIG. 25), the first support portion 5120, the second support portion 5130, and the third support portion 5140 of the knob unit 5100 are moved along with the knob main body 5110. Here, since the third support portion 5140 is movably accommodated in the fourth accommodation portion 5310 of the link unit 5300, the third support portion 5140 is moved inside the fourth accommodation portion 5310.

As described above, when the knob unit 5100 is moved to the right, the first contact portion 5422 of the second connector 5420 of the connecting unit 5400 accommodated in the third accommodation portion 5150 of the knob unit 5100 is pressed by the first support portion 5120 or the second support portion 5130 of the knob unit 5100 and moved in a direction in which the knob unit 5100 is moved. Here, since the first contact portion 5422 of the first connector 5410 is connected to the second contact portion 5424, the second contact portion 5424 of the first connector 5410 is also moved to the right (see FIG. 25) in conjunction with the movement of the first contact portion 5422.

When the second contact portion 5424 of the first connector 5410 is moved to the right, the fourth pinion portion 5412 of the first connector 5410 of the connecting unit 5400 engaged with the second contact portion 5424 and the pillar portion 5414 of the first connector 5410 which is connected to the fourth pinion portion 5412 are rotated counterclockwise (see FIG. 25). As the fourth pinion portion 5412 and the pillar portion 5414 of the first connector 5410 are rotated counterclockwise, the 2-1 wing unit 4100 and the 2-2 wing unit 4200 of the second wing unit 4000 connected to the pillar portion 5414 are rotated counterclockwise along with the pillar portion 5414. Accordingly, the 2-1 wing unit 4100 and the 2-2 wing unit 4200 may guide air passing through the first outlet portion 1420 and the second outlet portion 1440 of the housing 1000 toward the right side of the housing 1000.

In this way, the vehicle air vent 1 according to one embodiment of the present invention may eliminate the need for a separate power device for operating the first wing unit 3000 and the second wing unit 4000. Therefore, the manufacturing cost can be reduced and the power consumption for using the vehicle air vent 1 can be reduced, thereby reducing the power consumption of the vehicle.

According to one embodiment of the present invention, since the need for a separate power device for operating a first wing unit and a second wing unit is eliminated, manufacturing costs can be reduced. Additionally, since the power consumption of a vehicle can be reduced due to non-use of a power device, a decrease in vehicle efficiency can be prevented.

Although the present invention has been described above with reference to exemplary embodiments, those skilled in the art will understand that the present invention may be modified and changed in various ways without departing from the spirit and scope of the present invention as described in the appended claims. In addition, the differences relating to these modifications and changes should be construed as being included within the scope of the present invention as defined in the appended claims.

What is claimed is:

1. A vehicle air vent comprising:
a housing including a plurality of branch portions that branch air flowing inward in an upward or downward direction;
a garnish disposed in front of the housing and connected to the housing;
a first wing unit disposed in an inlet portion of the housing and configured to close at least one of the plurality of branch portions in the housing while being moved linearly inside the housing;
a second wing unit disposed in an outlet portion of the housing and configured to guide a movement direction of air while being rotated inside the housing; and
a handle assembly connected to the first wing unit and the second wing unit,
wherein the handle assembly includes a knob unit that passes through the garnish and is disposed inside and outside the garnish to determine a movement direction of air passing through the garnish.

2. The vehicle air vent of claim 1, wherein the knob unit includes a knob main body that is pressed by an external force, and
the knob main body is exposed through the garnish, and the first wing unit and the second wing unit are not exposed through the garnish.

3. The vehicle air vent of claim 1, wherein the handle assembly includes:
a gear unit disposed on an outer side of the housing and connected to the first wing unit to linearly move the first wing unit; and
a link unit that connects the knob unit and the gear unit.

4. The vehicle air vent of claim 3, wherein the plurality of branch portions of the housing include a first branch portion and a second branch portion, and
the first wing unit includes:
a first wing plate that is movable to close the first branch portion of the housing; and
a second wing plate that is spaced apart from the first wing plate and movable to close the second branch portion of the housing.

5. The vehicle air vent of claim 4, wherein the first wing plate and the second wing plate of the first wing unit are configured to be moved linearly in opposite directions while the gear unit is operated by the link unit moved in conjunction with movement of the knob unit.

6. The vehicle air vent of claim 4, wherein the gear unit of the handle assembly includes:
a first pinion portion coupled to the first wing plate;
a second pinion portion spaced apart from the first pinion portion and coupled to the second wing plate; and
a third pinion portion disposed between the first pinion portion and the second pinion portion, and which connects the first pinion portion and the second pinion portion and is connected to the link unit.

7. The vehicle air vent of claim 3, wherein the handle assembly includes a connecting unit that connects the knob unit and the second wing unit.

8. The vehicle air vent of claim 7, wherein the connecting unit of the handle assembly includes:
a first connector connected to the second wing unit; and
a second connector that rotatably supports the knob unit and is engaged and connected with the first connector.

9. The vehicle air vent of claim 8, wherein the second connector of the connecting unit rotates the first connector while being moved linearly in conjunction with movement of the knob unit.

10. The vehicle air vent of claim 1, wherein the housing and the garnish define a space that accommodates a part of the handle assembly in a state in which the housing and the garnish are connected.
